(19) United States
(12) Patent Application Publication
(10) Pub. No.: US 2025/0230060 A1
(43) Pub. Date: Jul. 17, 2025

(54) WATER PURIFIER

(71) Applicant: COWAY Co., Ltd., Gongju-si (KR)

(72) Inventors: Gun Wang LEE, Seoul (KR); Keun Hwan KIM, Seoul (KR); Woo Jin KANG, Seoul (KR); Heung Soo OH, Seoul (KR)

(73) Assignee: COWAY Co., Ltd., Gongju-si (KR)

(21) Appl. No.: 18/986,064

(22) Filed: Dec. 18, 2024

(30) Foreign Application Priority Data
Dec. 26, 2023 (KR) 10-2023-0191920

(51) Int. Cl. C02F 1/00; C02F 103/02

(52) U.S. Cl. CPC C02F 1/003; C02F 2103/02; C02F 2201/004; C02F 2209/02; C02F 2307/10

(57) ABSTRACT

A water purifier includes: a filter for filtering water; a cooling device for cooling water into cold water through heat exchange with a refrigerant; a main body supporting the cooling device; a pump disposed in the main body to be spaced apart from the cooling device; and a packing cover coupled to the main body and covering an outer surface of the pump so that the pump is sealed from an outside. A portion of the packing cover covers the pump between the pump and the body.

### TECHNICAL FIELD

The present disclosure relates to a water purifier.

### BACKGROUND

In general, a water purifier is a device that receives water from a water source such as a tap, filters it into purified water through an internal filter, and then provides the purified water to a user. Such a water purifier can provide not only purified water, but also hot and cold water to the user.

Conventional water purifiers may include a compressor for compressing refrigerant to cool water, and a pump for circulating the refrigerant. However, in the case of conventional water purifiers, there is a problem that if the refrigerant leaks from the compressor and a spark occurs in the pump, the refrigerant may ignite, causing a fire or explosion.

In this regard, Korean Utility Model Application Publication No. 20-2008-0001639 by the applicant, Kim Eui-gyeom, entitled “Hexagonal water manufacturing device for use as an air collection water purifier” (Patent Document 1), discloses a pump that transfers water to a filter and a compressor that is positioned at a certain distance above the pump (see FIG. 2). When the pump and compressor are positioned at different heights, even if refrigerant leaks from the compressor, the leaked refrigerant does not reach the pump, so that the risk of fire and explosion due to refrigerant leakage can be reduced.

However, since the water purifier disclosed in Patent Document 1 has a structure in which the pump and the compressor are arranged vertically, there is a problem in that it is difficult to use the water purifier of Patent Document 1 in a confined space with a limited height. In addition, there is a problem in that in products where the height of the water purifier itself is limited, such as countertop water purifiers or small water purifiers, the structure in which the pump and the compressor are arranged vertically cannot be applied to the water purifier.

### SUMMARY

In view of the above, the present disclosure provides a water purifier capable of preventing the risk of fire and explosion due to leakage of a highly explosive refrigerant.

In accordance with one embodiment of the present disclosure, there is provided a water purifier including: a filter for filtering water; a cooling device for cooling water into cold water through heat exchange with a refrigerant; a main body supporting the cooling device; a pump disposed in the main body to be spaced apart from the cooling device; and a packing cover coupled to the main body and covering an outer surface of the pump so that the pump is sealed from an outside, wherein a portion of the packing cover covers the pump between the pump and the body.

Further, the water purifier may further include a mounting bracket disposed between the packing cover and the main body to support the packing cover. The mounting bracket may include: a bracket member; a packing washer interposed between the packing cover and the bracket member, and having elasticity to seal an interior of the packing cover from an exterior of the packing cover; and a fastening member penetrating the packing washer, and having one end disposed between the bracket member and the main body and the other end inserted into the packing cover.

Further, the packing cover may include a material having elasticity.

Further, the packing cover may include a solid material made of plastic or metal.

Further, the pump may include: a pump body having a peripheral surface extending in one direction and provided with a harness wire; and a pump head providing a water inlet and a water outlet for water to enter and exit, and providing a water flow path between the pump head and the pump body. The packing cover may include: a packing body covering the peripheral surface of the pump body; and a packing head coupled to one end portion of the packing body to cover the pump head. Coupling portions between the packing body and the packing head may be arranged to overlap each other in a direction perpendicular to the one direction.

Further, the on an inner peripheral surface of an end portion of the packing head close to the packing body, a head step portion may be formed to be recessed in a direction perpendicular to the one direction. At the one end portion of the packing body, a body rib portion may be formed to face the head step portion and protrude in the one direction.

Further, the packing cover further includes a packing plug connected to the other end portion, opposite to the one end portion, of the packing body and configured to allow the harness wire to pass therethrough, and the packing body and the packing plug may be arranged to overlap each other in the direction perpendicular to the one direction.

Further, at the other end portion of the packing body, a body ledge portion protruding from an inner peripheral surface thereof may be formed, and a plurality of plug projections protruding radially outwardly may be formed on the packing plug so that the packing plug may be caught by the body ledge portion when the packing plug is coupled to the packing body.

Further, the packing plug may have a plug groove with an inner diameter at least smaller than an outer diameter of the harness wire in a state where the packing plug is separated from the packing body so that when the harness wire extends through the packing plug, the harness wire comes in tight contact with the plug groove of the packing plug.

Further, the refrigerant may include R-600 refrigerant which causes sparks in the pump when the R-600 refrigerant leaks from the cooling device and comes into contact with the pump.

Further, the cooling device may include a compressor, a condenser, an evaporator, and an expansion valve through which the refrigerant circulates, and the compressor may be disposed in the main body so that a bottom of the compressor is located at a lower height than a top of the packing cover.

Further, the water purifier may further include: a flow channel for allowing water to enter or exit the pump; and a fitting member having one end connected to the pump and the other end connected to the flow channel so that the flow channel communicates with the pump, wherein the packing cover may have a cover fitting hole through which the fitting member extends, and the fitting member may extend through the cover fitting hole such that at least a portion of the fitting member is in tight contact with the cover fitting hole, so that when the packing cover is separated from the main body, the fitting member is separated from the main body together with the pump while being connected to the packing cover and the pump.

Further, the fitting member may include: a fitting clip disposed at the water inlet and the water outlet; and a fitting connector disposed to overlap the cover fitting hole, one end of which is detachably connected to the flow channel, and the other end of which is coupled to the fitting clip. According to one embodiment of the present disclosure, by sealing the pump in the main body through the packing cover that completely covers the pump, even if a highly explosive refrigerant leaks from the cooling device (compressor), the risk of fire and explosion due to the leakage of the refrigerant can be prevented.

In addition, by interposing the packing washer between the packing cover and the bracket member, when the fastening member penetrates the bracket member to be coupled to the lower part of the pump, the packing washer can block the gap that occurs between the fastening member and the fixing hole of the pump.

Further, since the coupling portions between the packing body, packing head, and packing plug constituting the packing cover are arranged to overlap each other, even if the refrigerant leaks from the compressor, the packing cover can completely seal the pump from an outside.

Furthermore, since the fitting member connects the pump and the flow channel through the cover fitting hole of the packing cover, when the pump is separated from the main body, the fitting member can be separated from the main body together with the pump.

In addition, when the fitting member is disposed in the cover fitting hole, the fitting packing member is disposed in the cover fitting hole together with the fitting member, thereby achieving a seal at the cover fitting hole.

### BRIEF DESCRIPTION OF THE DRAWINGS

FIG. 1 is a perspective view illustrating main components of a water purifier according to one embodiment of the present disclosure.

FIG. 2 is an exploded perspective view of the main components in FIG. 1.

FIG. 3 is a side view of FIG. 1 as viewed from the side.

FIG. 4 is a front view of FIG. 1 as viewed from the front.

FIG. 5 is an exploded perspective view illustrating a packing cover according to one embodiment of the present disclosure.

FIG. 6 is a cross-sectional view taken along line VI-VI of FIG. 1.

### DETAILED DESCRIPTION

Hereinafter, specific embodiments for implementing a spirit of the present disclosure will be described in detail with reference to the drawings.

In describing the present disclosure, detailed descriptions of known configurations or functions may be omitted to clarify the present disclosure.

When an element is referred to as being ‘connected’ to, or ‘flowed’ into another element, it should be understood that the element may be directly connected to, or, flowed into another element, but that other elements may exist in the middle.

The terms used in the present disclosure are only used for describing specific embodiments, and are not intended to limit the present disclosure. Singular expressions include plural expressions unless the context clearly indicates otherwise.

Further, in the present disclosure, it is to be noted that expressions, such as the upper side and the lower side, are described based on the illustration of drawings, but may be modified if directions of corresponding objects are changed. For the same reasons, some components are exaggerated, omitted, or schematically illustrated in the accompanying drawings, and the size of each component does not fully reflect the actual size.

Terms including ordinal numbers, such as first and second, may be used for describing various elements, but the corresponding elements are not limited by these terms. These terms are only used for the purpose of distinguishing one element from another element.

In the present specification, it is to be understood that the terms such as “including” are intended to indicate the existence of the certain features, areas, integers, steps, actions, elements, combinations, and/or groups thereof disclosed in the specification, and are not intended to preclude the possibility that one or more other certain features, areas, integers, steps, actions, elements, combinations, and/or groups thereof may exist or may be added.

Hereinafter, a water purifier according to one embodiment of the present disclosure will be described with reference to the drawings.

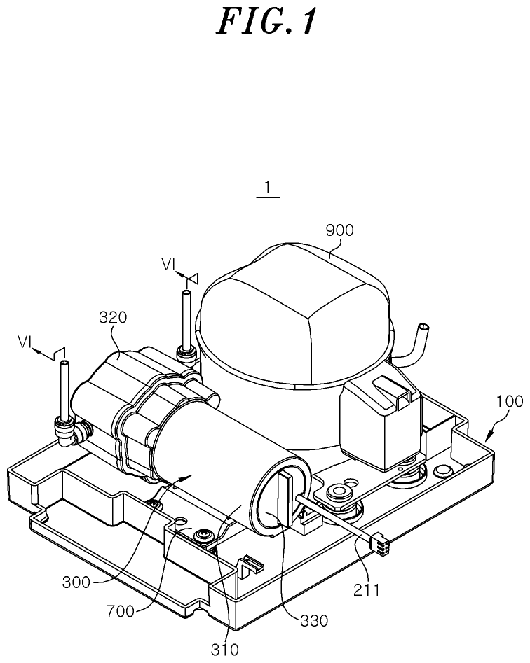

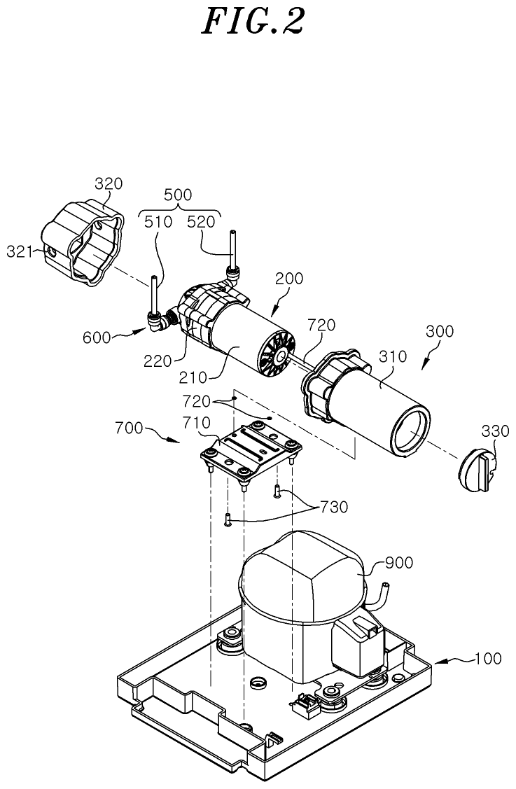

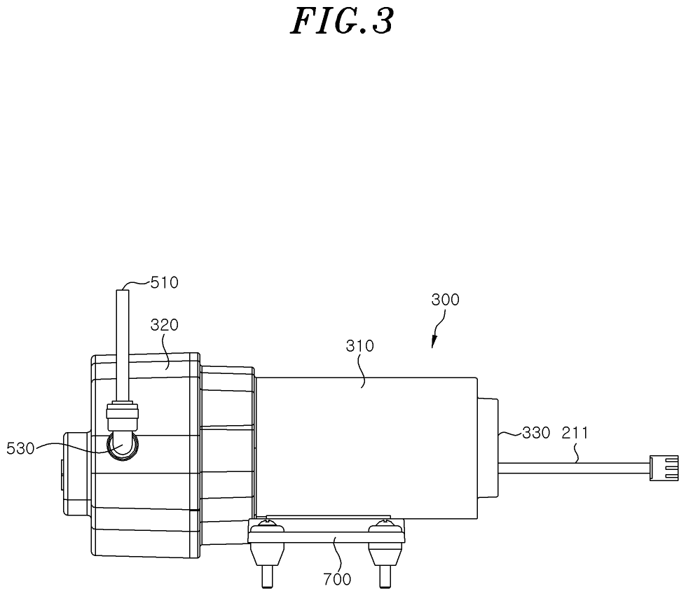

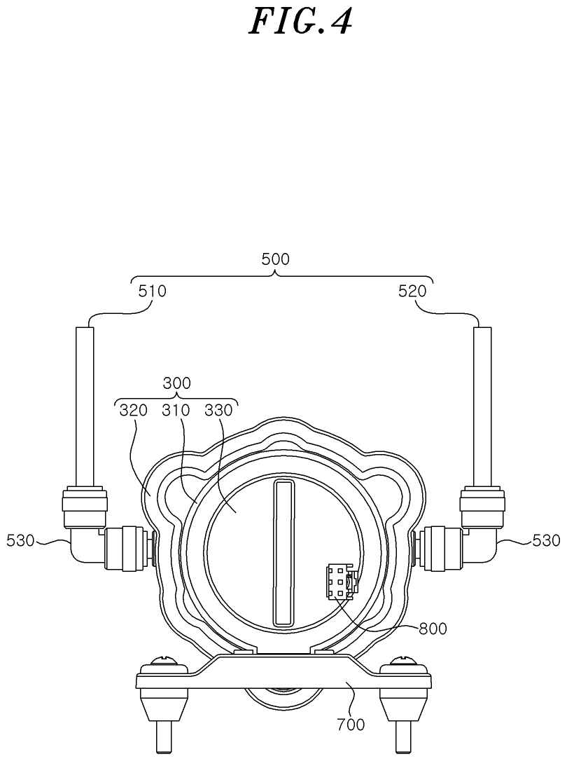

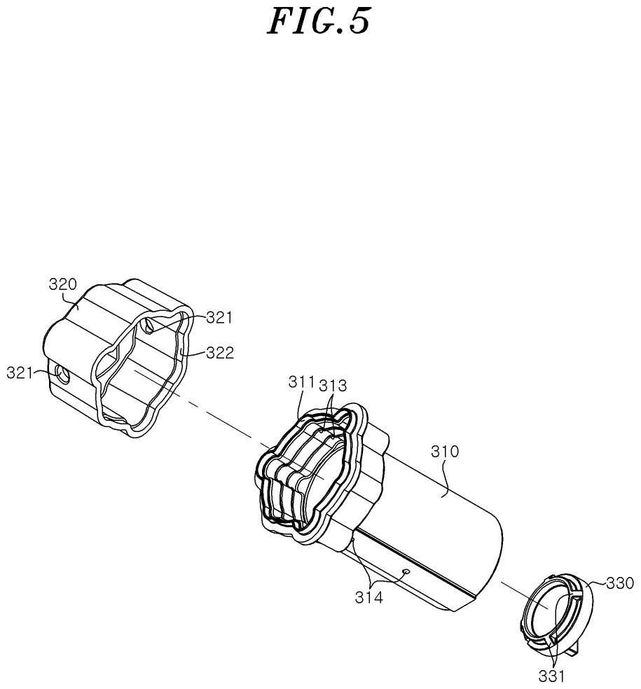

Referring to FIGS. 1 to 5, a water purifier according to one embodiment of the disclosure can provide purified water to a user by filtering raw water supplied from an external source. Such a water purifier 1 may include a main body 100, a pump 200, a packing cover 300, a flow channel 500, a fitting member 600, a mounting bracket 700, and a cooling device 900. Before a specific description, water introduced in the water purifier from an outside may include raw water and purified water. Hereinafter, water introduced in the water purifier from the outside that has not passed through a filter may be defined as raw water, and water introduced in the water purifier from the outside that has been filtered by the filter may be defined as purified water.

The main body 100 can support the pump 200, the packing cover 300, the mounting bracket 700, and the cooling device 900. The pump 200, the packing cover 300, the mounting bracket 700, and the cooling device 900 may be arranged on a bottom surface of the main body 100. The main body 100 may include the entire frame constituting the water purifier 1. In the present embodiment, the bottom surface of the main body 100 may be provided in the form of a flat base positioned at the bottom of the water purifier 1.

The pump 200 can provide pressure to move water in the flow channel 500. For example, the pump 200 can provide pressure to move raw water to the filter in the flow channel 500, or can provide pressure to move purified water that has passed through the filter to the outside. The pump 200 may be disposed on the bottom surface of the main body 100 to be spaced apart from the cooling device 900. When the pump 200 is disposed in the main body 100, the pump 200 may be disposed on the bottom surface of the main body 100 in a state in which it is entirely covered by the packing cover 300. The pump 200 may include a pump body 210 and a pump head 220.

The pump body 210 may cover the main components of a motor, for example, a rotor and a stator. The pump body 210 may have a peripheral surface extending in one direction. The pump body 210 may be provide with a harness wire 211 for receiving power from the outside.

The pump head 220 may provide a water inlet and a water outlet for water to enter and exit. The pump head 220 may be connected to the pump body 210 to communicate with the pump body 210. The pump head 220 may provide a path for water to move between the pump head 220 and the pump body 210. The pump head 220 may be connected to the flow channel 500 through the fitting member 600.

The packing cover 300 can cover the pump 200 between the pump 200 and the main body 100. The packing cover 300 can seal the pump 200 from the outside so that the pump 200 is sealed from the outside. The packing cover 300 may be disposed in the main body 100 in a state where it completely cover the pump 200. The packing cover 300 may include a material having elasticity. For example, the packing cover 300 may be a rubber material providing elasticity. Further, the packing cover 300 may include a solid material made of plastic or metal therein. The packing cover 300 may include a packing body 310, a packing head 320, and a packing plug 330.

The packing body 310 may cover the peripheral surface of the pump body 210 of the pump 200. At one end portion of the packing body 310, a body rib portion 311 that faces a head step portion 322 and protrudes in one direction may be formed. At the other end portion of the packing body 310, a body ledge portion 312 protruding from an inner peripheral surface thereof may be formed. The body ledge portion 312 may be fixed by being caught on a plug projection 331 of the packing plug 330 when the packing plug 330 is coupled to the packing body 310. In the present embodiment, a hook coupling method in which the body ledge portion 312 engages with the plug projection 331 of the packing plug 330 when the packing plug 330 is coupled to the packing body 310 has been described. However, the present disclosure is not limited to the hook coupling method, and various coupling methods in which the packing plug 330 and the packing body 310 can be coupled may be applied. For example, the packing plug 330 and the packing body 310 may be coupled by a coupling method such as heat fusing, taping, clipping, or screw coupling.

The packing head 320 may cover the pump head 220 of the pump 200. The packing head 320 may be coupled to one end of the packing body 310. A cover fitting hole 321 into which the fitting member 600 can be inserted may be formed in the packing head 320. The head step portion 322 to which the body rib portion 311 of the packing body 310 is coupled may be formed in the packing head 320. The head step portion 322 may be formed to be recessed in a direction perpendicular to one direction on an inner peripheral surface of an end portion of the packing head 320 close to the packing body 310. When the packing head 320 is coupled to the packing body 310, the body rib portion 311 may be disposed to overlap the head step portion 322. In other words, since the head step portion 322 and the body rib portion 311 overlap, the coupling portions of the packing body 310 and the packing head 320 are arranged to overlap each other in the direction perpendicular to one direction, so that the coupling portions of the packing body 310 and the packing head 320 can be in tight contact with each other.

The packing plug 330 may cover an end of the pump body 210. The packing plug 330 may be coupled to the other end of the packing body 310, which is opposite to one end of the packing body 310. The harness wire 211 may extend through the packing plug 330. When the packing plug 330 is coupled to the packing body 310, the packing body 310 and the packing plug 330 may be arranged to overlap each other in the direction perpendicular to one direction. Since the packing body 310 and the packing plug 330 are arranged to overlap each other, the coupling portions of the packing body 310 and the packing plug 330 can be in tight contact with each other.

A plurality of plug projections 331 protruding radially outwardly may be formed on the packing plug 330. When the packing plug 330 is coupled to the packing body 310, the plurality of plug projections 331 may be fixed by being caught on the body ledge portion 312 of the packing body 310. A plug groove 332 may be formed on the packing plug 330. The plug groove 332 may have an inner diameter that is at least smaller than an outer diameter of the harness wire 211 in a state where the packing plug 330 is separated from the packing body 310. When the harness wire 211 extends through the packing plug 330, the harness wire 211 can come in tight contact with the plug groove 332 of the packing plug 330.

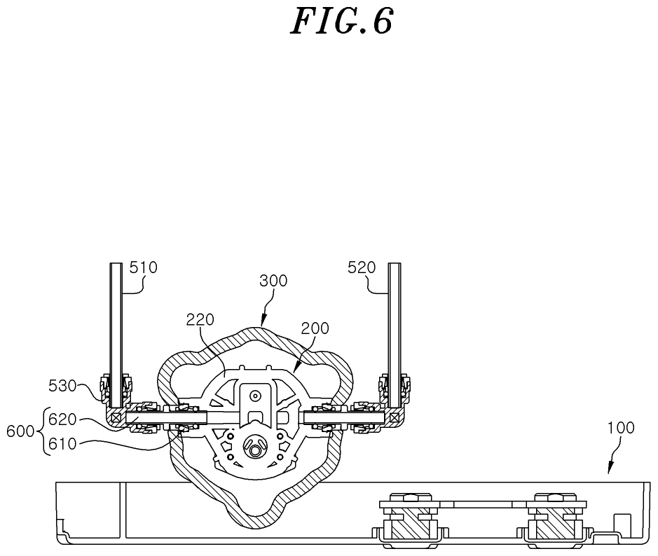

Referring to FIG. 6, the flow channel 500 may provide a passage through which water flows. In other words, the flow channel 500 may provide a passage for raw water moving to the filter, and may also provide a passage for purified water passing through the filter. The filter can filter raw water to provide purified water. The filter may include a filtering material capable of filtering raw water into purified water.

The flow channel 500 may be opened or closed by a valve. The flow channel 500 may be connected to the pump 200 through the fitting member 600 to receive or discharge water from or to the pump 200. The flow channel 500 may include an inlet pipe 510, an outlet pipe 520, and an elbow pipe 530.

The inlet pipe 510 may provide a path for water flowing into the pump 200. The inlet pipe 510 may be connected to the elbow pipe 530. The inlet pipe 510 can be in communication with a fitting connector 620 of the fitting member 600 through the elbow pipe 530. An outer diameter of the inlet pipe 510 corresponds to an inner diameter of the elbow pipe 530, so that the inlet pipe 510 can be fitted in and connected to the elbow pipe 530.

The outlet pipe 520 may provide a path for water discharged from the pump 200. The outlet pipe 520 may be connected to an elbow pipe 530. The outlet pipe 520 may be connected to the fitting connector 620 of the fitting member 600 through the elbow pipe 530. An outer diameter of the outlet pipe 520 corresponds to the inner diameter of the elbow pipe 530, so that the outlet pipe 520 can be fitted in and connected to the elbow pipe 530.

The elbow pipe 530 can guide water from the inlet pipe 510 to the pump 200, and guide water discharged from the pump 200 to the outlet pipe 520. The elbow pipe 530 may be connected between the inlet pipe 510 and the fitting connector 620. In addition, the elbow pipe 530 may be connected between the outlet pipe 520 and the fitting connector 620. The elbow pipe 530 may be connected to the inlet pipe 510 and the outlet pipe 520 in a sealed manner.

The fitting member 600 may connect the flow channel 500 to the pump 200. When the flow channel 500 is connected to the pump 200, one end of the fitting member 600 may be connected to the pump 200, and the other end of the fitting member 600 may pass through the cover fitting hole 321. When the packing cover 300 is separated from the main body 100, the fitting member 600 can be separated from the main body 100 together with the pump 200 while being connected to the packing cover 300 and the pump 200. The fitting member 600 may include a fitting clip 610 and a fitting connector 620.

The fitting clip 610 may connect the fitting connector 620 to the pump 200 in a sealed manner. The fitting clip 610 may be detachably fixed to the water inlet and the water outlet of the pump 200. Both ends of the fitting clip 610 may be connected between the fitting connector 620 and the elbow pipe 530.

The fitting connector 620 may be provided in the form of a pipe that allows communication between the flow channel 500 and the pump 200. The fitting connector 620 may be disposed to overlap the cover fitting hole 311. One end of the fitting connector 620 may be detachably coupled to the inlet pipe 510 and the outlet pipe 520 of the flow channel 500, and the other end of the fitting connector 620 may be detachably coupled to the fitting clip 610.

The mounting bracket 700 can support a lower part of the packing cover 300. A concave curvature surface corresponding to a convex curvature surface of the packing cover 300 may be formed on an upper part of the mounting bracket 700. The mounting bracket 700 may be disposed between the packing cover 300 and the main body 100. The mounting bracket 700 may be coupled to the main body 100 through a fastening bolt. The mounting bracket 700 may include a bracket member 710, a packing washer 720, and a fastening member 730.

The bracket member 710 may be disposed between the packing cover 300 and the main body 100 to support the lower part of the packing cover 300. The bracket member 710 may be fixed to the packing cover 300 through the fastening member 730 and may be fixedly disposed to the main body 100 through a separate fixing member. The bracket member 710 can support the lower part of the packing cover 300 with the packing washer 720 interposed therebetween.

The packing washer 720 may be disposed between the packing cover 300 and the bracket member 710. The packing washer 720 may be made of an elastic material. When the fastening member 730 penetrates the bracket member 710 to be coupled to the lower part of the packing cover 300, the packing washer 720 blocks a gap that occurs between the fastening member 730 and a fixing hole 314 of the packing cover 300, thereby sealing the interior of the packing cover 300 from the exterior of the packing cover 300.

The fastening member 730 may penetrate the bracket member 710 and the packing washer 720 to be coupled to the fixing hole 314 of the packing cover 300. When the fastening member 730 penetrates the bracket member 710 and the packing washer 720 to be coupled to the pump 200, one end of the fastening member 730 can be disposed between the bracket member 710 and the main body 100, and the other end of the fastening member 730 can be inserted into the packing cover 300.

The cooling device 900 can cool water into cold water through heat exchange with a refrigerant. In the present embodiment, a highly explosive refrigerant may be used. As an example, the refrigerant may be R-600 refrigerant. When the R-600 refrigerant leaks from the cooling device 900 and comes into contact with the pump 200, the R-600 refrigerant may cause a fire and explosion due to sparks from the pump 200.

In the present embodiment, R-600, which can help reduce global warming due to environmental regulations, may be used as the refrigerant. Since R-600 is a flammable refrigerant that is heavier than air and has a high explosive potential, when R-600 leaks from the cooling device 900 and comes into contact with the pump 200, R-600 may cause a fire and explosion due to sparks from the pump 200. Accordingly, in the present disclosure, the pump 200 is covered by the packing cover 300, so that even if R-600 leaks from the cooling device 900, the risk of fire and explosion due to the leakage of the refrigerant can be prevented.

The cooling device 900 may include a compressor, a condenser, an evaporator, and an expansion valve through which refrigerant circulates. The cooling device 900 illustrated in the drawing of the present embodiment may be a compressor. The compressor may be disposed on the bottom surface of the main body 100 on which the pump 200 is installed. The compressor may be disposed in the main body 100 such that the bottom of the compressor is located at a lower height than the top of the packing cover 300.

Hereinafter, the operation and effect of a water purifier according to one embodiment of the present disclosure will be described.

In the water purifier according to one embodiment of the present disclosure, the pump 200 is covered by the packing cover 300, so that the pump 200 can be sealed in the main body 100, and even if a highly explosive refrigerant leaks from the compressor, the risk of fire and explosion due to the leakage of the refrigerant can be prevented.

In addition, since the packing washer 720 is interposed between the packing cover 300 and the bracket member 710, when the fastening member 730 penetrates the bracket member 710 and is fastened to the lower part of the pump 200, the packing washer 720 can block the gap that occurs between the fastening member 730 and the fixing hole 314 of the pump 200.

Further, since the coupling portions between the packing body 710, the packing head 720, and the packing plug 730 that constitute the packer cover 300 are arranged to overlap each other, even if the refrigerant leaks from the compressor, the packing cover 300 can perfectly protect the pump 200 from the refrigerant.

Furthermore, the fitting member 600 connects between the pump 200 and the flow channel 500 through the cover fitting hole 321 of the packing cover 300, so that when the pump 200 is separated from the main body 100, the fitting member 600 can be separated from the main body 100 together with the pump 200.

In addition, when the fitting member 600 is disposed in the cover fitting hole 321, a fitting packing member is disposed in the cover fitting hole 321 together with the fitting member 600, thereby achieving a seal at the cover fitting hole 321.

The examples of the present disclosure have been described above as specific embodiments, but these are only examples, and the present disclosure is not limited thereto, and should be construed as having the widest scope according to the technical spirit disclosed in the present specification. A person skilled in the art may combine/substitute the disclosed embodiments to implement a pattern of a shape that is not disclosed, but it also does not depart from the scope of the present disclosure. In addition, those skilled in the art can easily change or modify the disclosed embodiments based on the present specification, and it is clear that such changes or modifications also belong to the scope of the present disclosure.

What is claimed is:

1. A water purifier comprising:
a filter for filtering water;
a cooling device for cooling water into cold water through heat exchange with a refrigerant;
a main body supporting the cooling device;
a pump disposed in the main body to be spaced apart from the cooling device; and
a packing cover coupled to the main body and covering an outer surface of the pump so that the pump is sealed from an outside,
wherein a portion of the packing cover covers the pump between the pump and the body.

2. The water purifier of claim 1, further comprising a mounting bracket disposed between the packing cover and the main body to support the packing cover,
wherein the mounting bracket includes:
a bracket member;
a packing washer interposed between the packing cover and the bracket member, and having elasticity to seal an interior of the packing cover from an exterior of the packing cover; and
a fastening member penetrating the packing washer, and having one end disposed between the bracket member and the main body and the other end inserted into the packing cover.

3. The water purifier of claim 1, wherein the packing cover includes a material having elasticity.

4. The water purifier of claim 1, wherein the packing cover includes a solid material made of plastic or metal.

5. The water purifier of claim 1, wherein the pump includes:
a pump body having a peripheral surface extending in one direction and provided with a harness wire; and
a pump head providing a water inlet and a water outlet for water to enter and exit, and providing a water flow path between the pump head and the pump body,
wherein the packing cover includes:
a packing body covering the peripheral surface of the pump body; and
a packing head coupled to one end portion of the packing body to cover the pump head, and
wherein coupling portions between the packing body and the packing head are arranged to overlap each other in a direction perpendicular to the one direction.

6. The water purifier of claim 5, wherein on an inner peripheral surface of an end portion of the packing head close to the packing body, a head step portion is formed to be recessed in a direction perpendicular to the one direction, and
wherein at the one end portion of the packing body, a body rib portion is formed to face the head step portion and protrude in the one direction.

7. The water purifier of claim 5, wherein the packing cover further includes a packing plug connected to the other end portion, opposite to the one end portion, of the packing body and configured to allow the harness wire to pass therethrough, and
wherein the packing body and the packing plug are arranged to overlap each other in the direction perpendicular to the one direction.

8. The water purifier of claim 7, wherein at the other end portion of the packing body, a body ledge portion protruding from an inner peripheral surface thereof is formed, and
wherein a plurality of plug projections protruding radially outwardly are formed on the packing plug so that the packing plug is caught by the body ledge portion when the packing plug is coupled to the packing body.

9. The water purifier of claim 7, wherein the packing plug has a plug groove with an inner diameter at least smaller than an outer diameter of the harness wire in a state where the packing plug is separated from the packing body so that when the harness wire extends through the packing plug, the harness wire comes in tight contact with the plug groove of the packing plug.

10. The water purifier of claim 1, wherein the refrigerant includes R-600 refrigerant which causes sparks in the pump when the R-600 refrigerant leaks from the cooling device and comes into contact with the pump.

11. The water purifier of claim 1, wherein the cooling device includes a compressor, a condenser, an evaporator, and an expansion valve through which the refrigerant circulates, and the compressor is disposed in the main body so that a bottom of the compressor is located at a lower height than a top of the packing cover.

12. The water purifier of claim 5, further comprising:
a flow channel for allowing water to enter or exit the pump; and
a fitting member having one end connected to the pump and the other end connected to the flow channel so that the flow channel communicates with the pump,
wherein the packing cover has a cover fitting hole through which the fitting member extends, and
wherein the fitting member extends through the cover fitting hole such that at least a portion of the fitting member is in tight contact with the cover fitting hole, so that when the packing cover is separated from the main body, the fitting member is separated from the main body together with the pump while being connected to the packing cover and the pump.

13. The water purifier of claim 12, wherein the fitting member includes:
a fitting clip disposed at the water inlet and the water outlet; and
a fitting connector disposed to overlap the cover fitting hole, one end of which is detachably connected to the flow channel, and the other end of which is coupled to the fitting clip.
